(19) United States
(12) Patent Application Publication
(10) Pub. No.: US 2008/0313036 A1
(43) Pub. Date: Dec. 18, 2008

(54) System and method for providing advertisements in online and hardcopy mediums

(76) Inventors: Marc Mosko, Santa Cruz, CA (US); Richard H. Bruce, Los Altos, CA (US); Nitin Parekh, Los Altos, CA (US); James (Bo) M.A. Begole, San Jose, CA (US); Lisa Fahey, San Francisco, CA (US); Eric Peeters, Fremont, CA (US)

Correspondence Address: CASCADIA INTELLECTUAL PROPERTY, 500 UNION STREET, SUITE 1005, SEATTLE, WA, 98101, US

(21) Appl. No.: 11/818,439

(22) Filed: Jun. 13, 2007

(51) Int. Cl. G06Q 30/00; G06Q 40/00

(52) U.S. Cl. 705/14; 705/39

(57) ABSTRACT

A system and method for providing advertisements in online and hardcopy mediums is presented. Advertising content is targeted to a target audience. The characteristics of the target audience are analyzed against the advertising content to identify potential advertisers. At least one of the potential advertisers is selected. One or more advertisements for the selected advertiser is included on a document. The document is provided on at least one of online and hardcopy mediums.

### FIELD

This application relates in general to online and hardcopy advertising and, in particular, to a system and method for providing advertisements in online and hardcopy mediums.

### BACKGROUND

Advertising, whether online or printed, is most effective when delivered to readers who would likely have an interest in the products or services being offered. For instance, Web-based advertising can be tied into the content of a Web page being served, such as through sponsored hyperlinks, and email promotional materials, including “junk” email, are frequently distributed to existing online customers. Likewise, print advertising in newspapers, for example, is often directed to readers who are demographically identified, whereas print advertising in magazines and periodicals often relates to the publication's theme or articles.

Advertising is generally intended to create an interest in or to generate an awareness of products or services, and effectively targeting online and print advertising includes knowing the characteristics of the intended readership to ensure that the advertisements are both topical and eye-catching. A priori knowledge of a readership's characteristics may be difficult to gauge. Web publishers experience a readership that is ad hoc when materials are posted for unrestricted access. Similarly, the characteristics of the readership of documents printed for limited circulation or personal use are generally unknowable.

For conventional print documents, delivering advertising to a small audience remains particularly difficult because “short run” printing is relatively closed-ended and most advertisers lack access to the readership. Moreover, without access, advertisers can neither determine the readers' characteristics for effectively targeting advertising, nor place print advertisements into the documents economically. The costs of advertising can also disfavor small merchants, where revenue potentially gained may not justify the cost, especially if the small merchants must compete against larger and better known competitors.

And even where access to the readership is available, an inability to obtain characteristics and demographics beyond any information already voluntarily disclosed can hinder advertisement targeting. For instance, the specter of identity theft and fear of receiving “junk” mail can undermine the willingness of individuals to divulge their personal information to third parties. Web publishers often rely on “cookies” to authenticate, track, and store user information, but cookies are only helpful in identifying repeat Web page visitors. The targeting of advertising to small audience markets can therefore be a gamble when little information about the readerships' characteristics is known with certainty.

Conventional efforts to target and place advertising have focused on online advertising. For instance, Google, Inc., Mountain View, Calif., offers a targeted Web advertising program called AdSense. The pages for customers' Websites are automatically crawled and sponsored advertisements are placed in the margins based on the audience and Web page content. Customers are paid whenever visitors to their Website click on the placed advertisements. Thus, the potential for receiving advertising revenue provides an incentive for customers to allow targeted sponsored advertising. However, the incentives are limited to Web-displayable content and are unavailable to publishers of hardcopy short printing runs or individual printing, even where those publishers possess further readership characteristics or could offer additional incentives for printed placed advertising.

U.S. Pat. No. 6,269,361, issued Jul. 31, 2001 to Davis et al. discloses matching search results to advertiser Web pages by matching words parsed from user search queries, the disclosure of which is incorporated by reference. The positions of entries for advertiser Web pages in the search listings are influenced through a continuous online competitive bidding process between the advertisers. A “click-through” payment model charges the advertisers for placement, which is triggered when a user selects an advertiser hyperlink. However, advertising is limited to online advertisements embedded into Web pages and not in hardcopy.

U.S. Pat. No. 6,891,635, issued May 10, 2005 to Dutta discloses a system and method for providing advertisements in Web-based printing in which a remote printing Web server receives advertisements from one or more advertisers, the disclosure of which is incorporated by reference. The advertisements can include target audience attributes. A print user connects to the remote printing Web server and information about the user is gathered to match advertisements, which are combined with a document that the user wishes to print. The printer hosting site is paid by the advertisers for including their advertisements in printouts. However, the advertising is limited to print advertising and is selected only by user-provided information, not document content. Nor is the user-provided information advantageously “mined” to generate targeted information, which could be provided to social groups, such as clubs, and other organizations that have a potentially shared interest. Moreover, the advertising is provided for paying advertisers who are not competitively selected.

U.S. Pat. No. 7,065,497, issued Jun. 20, 2006 to Brewster et al. discloses a system and method for automatically printing a document without user intervention, the disclosure of which is incorporated by reference. A user profile, which stores information about the document recipient, such as name, email address, household income, and interests, is stored and updated when a document is printed. The user profile can be used to select information or advertising likely to be of interest to the user to be included in the printed document. A product can be subsidized for a user, such as a print consumable, based on the information contained in the user profile. However, the advertising is limited to print and not online advertising. As well, the print advertising is selected only by user profile information and not document content. Moreover, the advertising is provided for designated advertisers who are not competitively selected.

Therefore, there is a need for providing targeted advertisement placement on both online Web pages and hardcopy print documents.

### SUMMARY

One embodiment provides a system and method for providing advertisements in online and hardcopy mediums. Advertising content is targeted to a target audience. The characteristics of the target audience are analyzed against the advertising content to identify potential advertisers. At least one of the potential advertisers is selected. One or more advertisements for the selected advertiser is included on a document. The document is provided on at least one of online and hardcopy mediums.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWING

FIG. 1 is a functional block diagram showing a system for providing advertisements in online and hardcopy mediums in accordance with one embodiment.

FIG. 2 is a process flow diagram showing a method for providing advertisements in online and hardcopy mediums in accordance with one embodiment.

FIGS. 3 and 4 are pictorial diagrams respectively showing, by way of example, online advertising on a Web page and print advertising on printed hardcopy.

### DETAILED DESCRIPTION

### Terms

As used herein, the terms “online advertising” and “print advertising” refer to advertisements and sponsored information, which can include text and visuals, plus sound and video for interactive media, that are included in online-viewable and physically printed publications, such as Web pages, email, books, periodicals, magazines, catalogs, newsletters, documents, and various forms of writings. The terms “document,” “publication,” and “writing” refer to written content that can be read or viewed, either online or in print, and can include a complete work, an excerpt or portion of a writing, or any other textual or visual material that can be viewed or physically printed. In a further embodiment, the terms “document,” “publication,” and “writing” refer to also refer to written content that has been converted into an audio, video, or other form of multimedia, such as an audio book. Additionally, the terms “author,” “creator,” “writer,” “contributor,” and “publisher” refer to the originator of online content or printable documents, and the terms “reader,” “consumer,” and “user” refer to the intended reader or viewer of the online content, printable documents, or advertising placed on either the content or documents. As well, the terms “characteristics,” “attributes,” and “demographics” refer to information about readers, which enables print advertising to be targeted, either to the readers collectively or individually. The terms “displaying,” “outputting,” and “rendering” refer to the process of providing online content, particularly Web pages, to a viewer, while the terms “printing” and “publishing” refer to the physically process of outputting a hardcopy document. Finally, although described with particular focus on advertising content, other types of non-advertising information and content could be provided. Each of the terms can be used interchangeably and, unless otherwise noted, will have similar meanings.

### Online and Print Advertising Environment

Providing effective online and print advertising to an ad hoc readership base, such as experienced by a Web publisher, or to a small audience of readers, such as a social or special interest group or individuals with particular interests, can be achieved by gaining access to the underlying processes of Web browsing and physical document printing. Servable Web content generally contains information, such as keywords and metadata, that can be used to target online advertising. Printable documents similarly contain potentially useful information. As well, obtaining access to the characteristics of the readership, although not obligatory, can further improve the effectiveness of advertisement targeting, particularly where Web or print document content alone provide insufficient context for effective targeting.

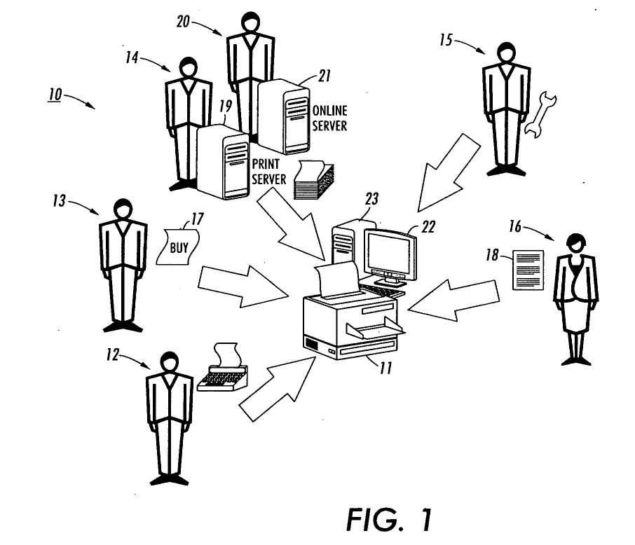

In general, advertising placement in online and print media implicates the participation of five logical entities, although under some circumstances, many of the entities could actually be the same person or system, as further explained below. FIG. 1 is a functional block diagram showing a system 10 for providing advertisements in online and hardcopy mediums in accordance with one embodiment. A document publisher 12 creates or writes new online content, particularly Web pages, or printable documents, or accesses existing content, documents, or other printable material, which are both referenced generically as documents 18. The online content is published, such as through an online server, for access and viewing by a document reader 16 online. Web content published online, for example, can be accessed and viewed on a Web-enabled device, such as a personal computer 22, through a Web browser 23, while email is downloaded by an email client for viewing by addressees. Printable documents can be accessed and physically printed by a document printer 15 on a printing device 11, which can be separately read or viewed by the document reader 16. Alternatively, the document reader 16 can both physically print and read printable documents using a personal printing device. The document publisher 12, document printer 15, and document reader 16 can be separate or combined entities, such as in the case of an individual writing and printing documents for personal use.

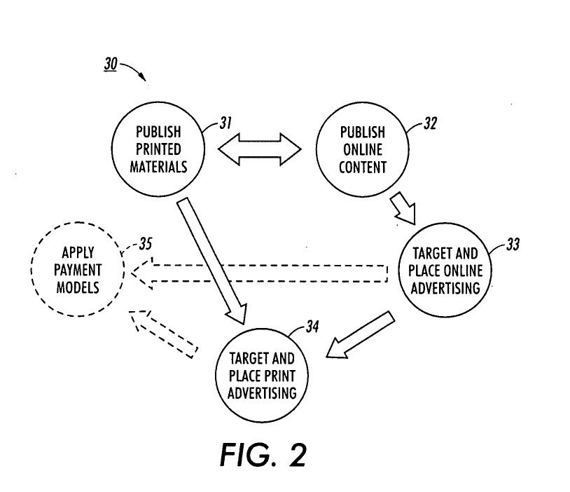

Ordinarily, an advertiser 13 that wants to target and place online or print advertising on online content or printable documents would lack access to the details of an ad hoc readership or the physical printing process for a short printing run, particularly where the printing is by an individual. Access to the physical printing process can be provided through an electronic marketplace operator 14, who can directly or indirectly participate in the physical printing process and can provide print advertising on behalf of an advertiser 13. Similarly, access to an ad hoc readership can be provided through an online marketplace operation 20, who can provide online advertising on behalf of an advertiser 13. Both forms of print and online readership access are further described below with reference to FIG. 2. Other forms of access are possible. Both the print and online advertising provisioning can be performed through manual selection, or by a machine, such as print server 19 and online server 21, using rule-based or other selection processes.

Both the documents 18 and advertising content 17 are stored in electronic form, which can be exchanged between computing, viewing, and printing devices over a network, such as the Internet. The document publisher 12, who writes documents 18, and the document reader 16, who views or reads documents, have access to the documents, either directly, such as in the form of a file or hardcopy, or indirectly, such as where a document publisher 12 contributes only a portion of the material that is included in a finished document 18. The advertiser 13, electronic marketplace operator 14, and online marketplace operator 20 can have full or restricted document access. For example, advertisers 13 may be limited to accessing only the characteristics or metadata about a document 18, which can be in the form of keywords, digests, or other forms of abstracted or summarized data. Similarly, the document printer 15 can have access to the document, as necessary for rendering as hardcopy on a printing device, either directly or indirectly.

Each computing device can be a personal computer, Web-enabled device, or other type of device designed for document perusal or composition. The printing device 11 can be a xerographic, flexographic press, offset press, laser, inkjet, daisy wheel, dot matrix, or other type of device designed to output hardcopy documents on paper or other physical human-readable media, particularly where the printing device is adapted to short printing runs. Other types of computing and printing devices are possible.

### Online and Print Advertising Process

Advertisements can be targeted and placed into documents, which are viewed online, printed, or both, and the specific advertisements can be provided through different media channels. FIG. 2 is a process flow diagram showing a method for providing advertisements in online and hardcopy mediums 30 in accordance with one embodiment. The method is performed as a series of process steps by general purpose programmable computing device, such as a server, personal computer, or other network-connectible device, in conjunction with an online display or printing device.

Initially, printed materials and online content are published (operations 31 and 32, respectively). The publication of the materials can occur as coordinated or distinct operations by the same or different publishers 12. The printed materials can include paper and other forms of print media. The online content can include Web content, email, or unstructured collections of electronic documents, such as a folder containing Word processing, spreadsheet, or digital image or music files. The content qualifies as being “online,” whether temporarily or permanently available, provided the device through which access is obtained is connected to a network, which is preferably a publicly-accessible network, such as the Internet.

Advertising can be targeted and placed onto the online content and printed materials respectively as online advertising (operation 33) and print advertising (operation 34). The advertising appears as part of the displayed or printed document, generally placed along the margin or in an area delimited from the document itself, although the placement is not crucial so long as the advertising is associated with the online content or printed materials. The online and printed advertising targeting and placement occur as distinct operations, although the entity or entities responsible for the provisioning of the advertising can be under combined “single” or separate “dual” models of representation, as further described below. In a further embodiment, a payment model is applied following advertising provisioning (operation 35). The online and print advertising can also include a tracking number, special formatting, or other types of identifiers with each advertisement, which can enable the effectiveness of the advertisements to be tracked. Other operations are possible.

The online advertising can be targeted and placed by the online marketplace operator 20 through various approaches. For instance, the online advertising can be targeted based upon the document's content, including any associated metadata, by applying keyword matching or related approaches. The online advertising could also be targeted by matching words parsed from user search queries, such as described in U.S. Pat. No. 6,269,361, described supra. Additionally, the online content can be targeted through a Web advertising program, such as Google Inc.'s AdSense program, described supra. Incentives, such as advertising revenue, can be provided in exchange for allowing online advertising. Still other approaches to targeting online advertising are possible.

Similarly, the print advertising can be variously targeted and placed by the electronic marketplace operator 14. For example, print advertising can be targeted to documents printed for a small audience as part of the physical printing process by publishers for readers who have agreed to divulge their characteristics and demographics, such as described in commonly-assigned U.S. patent application, entitled “System and Method for Providing Print Advertisements,” Ser. No. ______, filed Jun. 13, 2007, pending, the disclosure of which is incorporated by reference. The targeting can be to individuals or social groups, which include non-profit groups, such as clubs, teams, leagues, and other bodies, whose members are often demographically similar or engaged in pursuing a particular activity, or for other forms of print advertising, such as generating catalogs and marketing materials for non-sponsored advertisers. Other types of targeting are possible. Incentives, such as advertising revenue, can be provided in exchange for allowing printed advertising. The print advertising targeting and placement can occur in near real time, that is, during the time interval between a printing request and the physical printing of a document or at other times, such as during document creation. Still other approaches to targeting print advertising are possible.

Where advertising is targeted and placed into documents that are available as both printed materials and online content, a single “generic” representation of the document can be used. For example, Cascading Style Sheets (CSSs) are available for Web content written in a markup language, such as the Hypertext Markup Language (HTML). CSSs enable a single HTML document to represent both Web content and hardcopy and can include provisions to automatically place and format advertising in both online and printed forms, such as described in E. Meyer, “CSS Design: Going to Print,” http://alistapart.com/stories/goingtoprint (May 10, 2002), the disclosure of which is incorporated by reference.

“Single” Representation

Under the “single” representation model, the online and print advertisement targeting and placement can be performed by an online marketplace operator 20 and electronic marketplace operator 14 who are the same entity. Thus, the advertisements are both targeted and placed on the online content as viewed and on printed documents by a single entity that represents all of the advertisers 13. Other forms of single representation are possible, particularly for the provisioning of general non-advertising information and content.

The single representation of advertisers 13 provides several approaches to online and print advertisement targeting and placement. The online and print advertisements can be substituted in a one-to-one fashion or can be the same advertisements, albeit in different media. As an example, when substituted, a text link displayed online could be converted into a printable graphic from the same advertiser 13, or as a discount coupon or other identifier for the advertiser 13. Alternatively, the same advertisements can be provided, but in different orderings or rankings for online versus printed forms. Still other single representation approaches advertisement to targeting and placement are possible.

“Dual” Representation

Under the “dual” representation model, the online marketplace operator 20 and electronic marketplace operator 14 can be different entities, who together provide separate forms of representation. The targeting and placement of advertisements occur as distinct operations and the advertisements, as well as the corresponding advertisers 13, need not be matching. If payment models are used, separate or consolidated payments can be earned by the online marketplace operator 20 and electronic marketplace operator 14 as appropriate. Other forms of dual representation are possible, particularly for provisioning of general non-advertising information and content.

The dual representation of advertisers 13 provides also a number of approaches to online and print advertisement targeting and placement. For example, an advertisement for a merchant offering nationwide goods or services can be provided with online content, while an advertisement for a local merchant offering the same types of goods or services could be provided in print form. Similarly, different brands, or different individual goods or services offered by the same advertiser could be advertised online and in hardcopy. Additionally, different advertisers 13 could be selected on the basis of sponsorships or other criteria that may favor advertising placement from one set of advertisers over other advertisers. For instance, where the online advertisers 13 are chosen based on sponsored content or results, the print advertisers 13 could be selected as being non-sponsoring. Conversely, the online marketplace operator 20 and electronic marketplace operator 14 could implement filters or screening operations that limit, restrict, or exclude certain forms of advertisements, such as filters that prohibit advertisements from competitors or as adult or restricted content, or screens that limit advertisers to a local area. Still other dual representation approaches to targeting and placement are possible. Finally, further models of online and printed advertising representation, either in lieu of or in addition to single and dual representation are possible.

### EXAMPLES

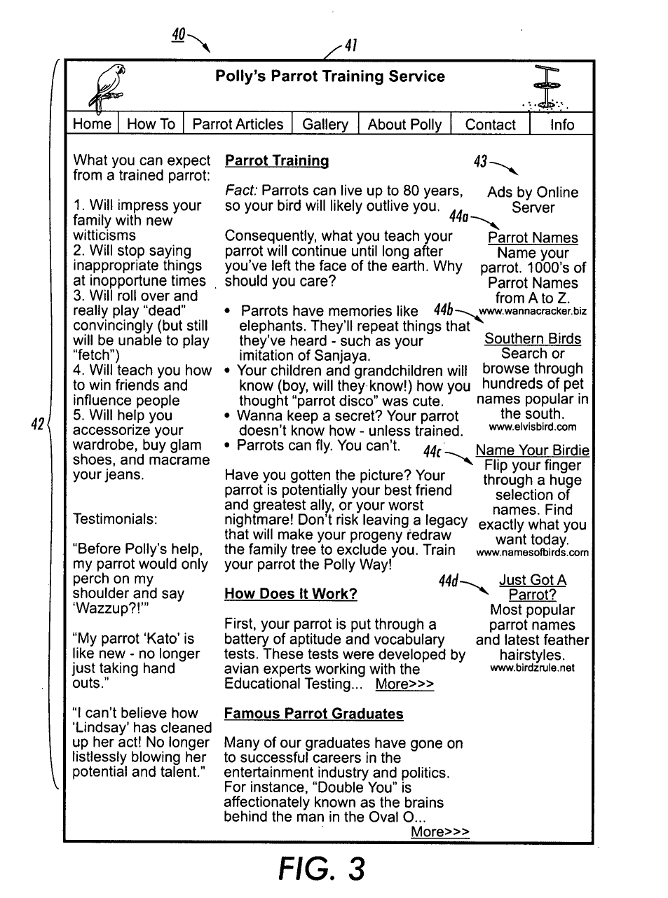

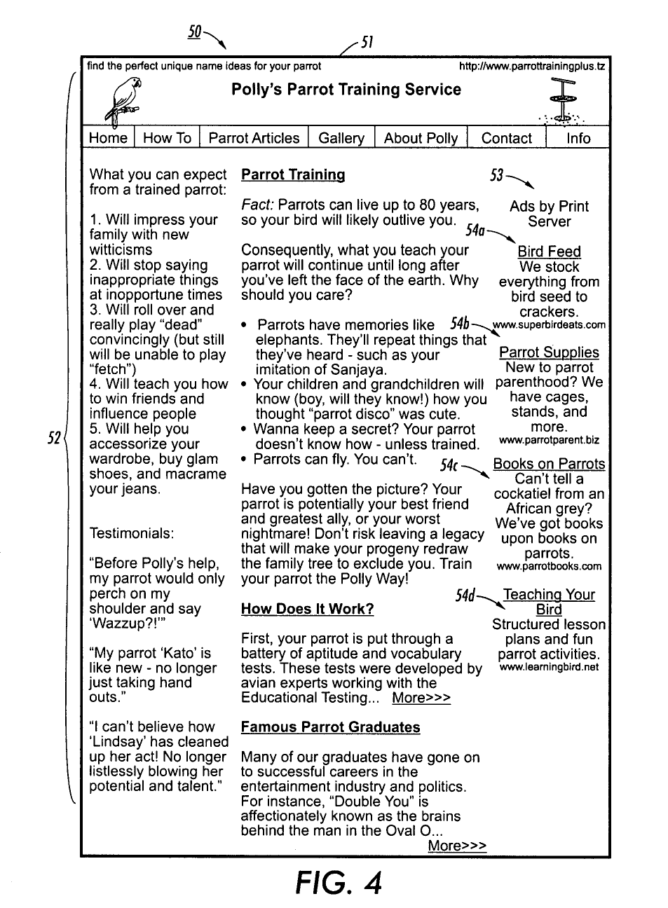

The targeting and placement of advertisements in online content and printed documents both involve supplementing underlying materials with advertising content on behalf of advertisers 13. FIGS. 3 and 4 are pictorial diagrams respectively showing, by way of example, online advertising 40 on a Web page 41 and print advertising 50 on printed hardcopy 51. The advertisement targeting and placement can occur under single or dual representation, and can be provided for either online or print media only, or for both. Additionally, although described with specific reference to Web pages, the targeting and placement applies generally to any form of online content, including email.

Online Advertising

Referring first to FIG. 3, a Web page 41 includes underlying online materials 42 that can include text, graphical or photographic images, and other content capable of being rendered through an online display, including digitally encoded data primarily intended for machine-interpretation, such as barcodes, glyphs, and other forms of digital encodings. The underlying online materials 42 can also sound and video for interactive media displays. Still further forms of underlying online materials are possible.

An online marketplace operator 20 can target and place online advertisements 44a-d with the Web page 41. The online advertisements 44a-d can be included in the same or different form as the underlying online materials 42, either with or without a hyperlink to the online advertiser's Website, and can be placed in the margin or in any other location within or in conjunction with the Web page 41, such as via a popup window. In addition, the online advertisements 44a-d include both sponsored and non-sponsored online advertising, with sponsorship 43 indicated as appropriate.

Printed Advertising

Referring next to FIG. 4, a printed hardcopy 51 also includes underlying printed materials 52, which correspond to the underlying online materials 42. However, as a form of printed document, the underlying printed materials 52 are limited to text, graphical or photographic images, and other content capable of being rendered through in hardcopy, including digitally encoded data primarily intended for machine-interpretation. Still further forms of underlying printed materials are possible.

An electronic marketplace operator 14 can target and place printed advertisements 54a-d with the printed hardcopy 51. The printed advertisements 54a-d can be included in the same or different form as the underlying printed materials 51, and can be placed in the margin or in any other location within or in conjunction with the printed hardcopy 51, such as on a print job separator sheet. In addition, the printed advertisements 54a-d include both sponsored and non-sponsored printed advertising, with sponsorship 53 indicated as appropriate.

In a further embodiment, providing printed advertisements 54a-d with printed hardcopy 51 presents an intermediate hybrid form of online advertising. Frequently, a document reader 16 (shown in FIG. 1), such as a Web browser 23, will execute a printer driver that can generate a print preview screen prior to sending a document to a document printer 15 for printing on a printing device 11. The print preview screen shows the online content as an online rendering of how the document will appear in hardcopy. Thus, the print preview screen could be supplemented with advertisements, either in lieu of or in addition to the printed advertisements 54a-d that will appear with the printed hardcopy 51. Further forms of hybrid advertising are possible.

Depending upon the form of representation, the online advertisements 43a-d and printed advertisements 54a-d could be matching or distinct. Matching online and printed advertisements from the same advertiser could be presented in the same form or in different forms depending upon the media. For instance, an online advertisements that includes a hyperlink to the advertiser's Website could be printed as a redeemable coupon.

Content Besides Advertising

In a further embodiment, content either in lieu of or in addition to online advertisements 43a-d and printed advertisements 54a-d could be targeted and placed by the online marketplace operator 20 and electronic marketplace operator 14. For example, public service announcements could be effectively placed by targeting the announcements using the same approaches as used for advertising.

While the invention has been particularly shown and described as referenced to the embodiments thereof, those skilled in the art will understand that the foregoing and other changes in form and detail may be made therein without departing from the spirit and scope.

What is claimed is:

1. A system for providing advertisements in online and hardcopy mediums, comprising:
an advertising server to target advertising content to a target audience, comprising:
an analyzer to analyze the characteristics of the target audience against the advertising content to identify potential advertisers;
a selector to select at least one of the potential advertisers; and
a merger to include one or more advertisements for the selected advertiser on a document; and
an output device to provide the document on at least one of online and hardcopy mediums.

2. A system according to claim 1, wherein the targeting is performed through a single online and electronic marketplace.

3. A system according to claim 2, further comprising one or more of:
a substitution component to provide one of the same advertisements for the online and hardcopy mediums and different advertisements for the online and hardcopy mediums; and
an ordering component to change at least one of an ordering and ranking of the advertisements for the online and hardcopy mediums.

4. A system according to claim 1, wherein the targeting for the online media is performed through an online electronic marketplace, and the targeting for the hardcopy media is performed through a hardcopy electronic marketplace.

5. A system according to claim 4, wherein the online electronic marketplace and the hardcopy electronic marketplace select the advertisements comprising one or more of:
a localizer component to provide at least one advertisement for a national merchant and at least one advertisement for a local merchant, wherein both advertisements relate to the same types of goods or services;
a brand selector component to select the advertisements for different brands or different goods or services offered by the same advertiser;
a sponsor selector component to select the advertisements based on sponsorship or non-sponsorship; and
a filter component to implement at least one of a filter and a screen to limit, restrict, or exclude the advertisements.

6. A system according to claim 1, further comprising:
an online media targeting component to perform the targeting for the online media, comprising at least one of:
a keyword matching component to apply keyword matching to the advertisements;
a user search query component to match words parsed from user search queries to the advertisements; and
a Web crawler to crawl Websites for one or more advertisers and placing the advertisements into pages in the Website.

7. A system according to claim 1, further comprising:
a hardcopy media targeting component to perform the targeting for the hardcopy media, comprising at least one of:
a printing device to provide the advertisements to individuals as part of a physical printing process;
a layout device to include the advertisements in a layout of the document for a social group; and
a print engine to create print advertising with the advertisement for a non-sponsored advertiser.

8. A system according to claim 1, wherein Web-based targeting of the advertising content to the target audience is provided in addition to the print advertisements.

9. A system according to claim 1, further comprising:
a payment model applied by paying compensation to at least one of an online electronic marketplace and a hardcopy electronic marketplace at a time of redemption of the advertisement by one or more readers in the target audience.

10. A system according to claim 9, further comprising:
one or more of a tracking number and special formatting with the advertisement, wherein effectiveness of the advertisements can be tracked through the tracking number or special formatting.

11. A method for providing advertisements in online and hardcopy mediums, comprising:
targeting advertising content to a target audience, comprising:
analyzing the characteristics of the target audience against the advertising content to identify potential advertisers;
selecting at least one of the potential advertisers; and
including one or more advertisements for the selected advertiser on a document; and
providing the document on at least one of online and hardcopy mediums.

12. A method according to claim 11, further comprising:
performing the targeting through a single online and electronic marketplace.

13. A method according to claim 12, further comprising one or more of:
providing the same advertisements for the online and hardcopy mediums;
providing different advertisements for the online and hardcopy mediums; and
changing at least one of an ordering and ranking of the advertisements for the online and hardcopy mediums.

14. A method according to claim 11, further comprising:
performing the targeting through an online electronic marketplace for the online media; and
performing the targeting through a hardcopy electronic marketplace for the hardcopy media.

15. A method according to claim 14, wherein the online electronic marketplace and the hardcopy electronic marketplace select the advertisements comprising one or more of:
providing at least one advertisement for a national merchant and at least one advertisement for a local merchant, wherein both advertisements relate to the same types of goods or services;
selecting the advertisements for different brands or different goods or services offered by the same advertiser;
selecting the advertisements based on sponsorship or non-sponsorship; and
implementing at least one of a filter and a screen to limit, restrict, or exclude the advertisements.

16. A method according to claim 11, further comprising:
performing the targeting for the online media, comprising at least one of:
applying keyword matching to the advertisements;
matching words parsed from user search queries to the advertisements; and
crawling Websites for one or more advertisers and placing the advertisements into pages in the Website.

17. A method according to claim 11, further comprising:
performing the targeting for the hardcopy media, comprising at least one of:
providing the advertisements to individuals as part of a physical printing process;
including the advertisements in a layout of the document for a social group; and
creating print advertising with the advertisement for a non-sponsored advertiser.

18. A method according to claim 11, further comprising:
providing Web-based targeting of the advertising content to the target audience in addition to the print advertisements.

19. A method according to claim 11, further comprising:
applying a payment model by paying compensation to at least one of an online electronic marketplace and a hardcopy electronic marketplace at a time of redemption of the advertisement by one or more readers in the target audience.

20. A method according to claim 19, further comprising:
including one or more of a tracking number and special formatting with the advertisement; and
tracking effectiveness of the advertisements through the tracking number or special formatting.

21. A computer-readable storage medium holding code for performing the method according to claim 11.
